(19) United States
(12) Patent Application Publication
(10) Pub. No.: US 2004/0260731 A1
(43) Pub. Date: Dec. 23, 2004

(54) System and method of shared file and database access

(76) Inventors: Ryan Zalmon Pickford, Midrand (ZA); Carl Reinhardt Essafrau, Sandten (ZA)

Correspondence Address: KNOBBE MARTENS OLSON & BEAR LLP, 2040 MAIN STREET, FOURTEENTH FLOOR, IRVINE, CA, 92614, US

(21) Appl. No.: 10/871,339

(22) Filed: Jun. 18, 2004

(30) Foreign Application Priority Data
Jun. 18, 2003 (ZA) 2003/4703

(51) Int. Cl. G06F 17/30

(52) U.S. Cl. 707/104.1

(57) ABSTRACT

A shared file and database access system is disclosed, which comprises a database of information relating to employee characteristics including an interview, and at least one communication port allowing access to the database. In one embodiment, the system is operable through the communication port to select information from the database for displaying on a display device. In one embodiment, the communications port is connectable to a network, which may include a local area network, a wide area network and the Internet

### BACKGROUND OF INVENTION

1. Field of the Invention

This invention relates to a system and method of shared file and database access, and more particularly, to systems and methods that use databases which include multimedia and text files associated with employment seekers and which are accessible via a network.

2. Description of the Related Technology

Employment systems offer prospective employers and employment seekers various resources to match employment needs with available skills. These resources include newspaper and trade journal advertisements, employment agencies, word of mouth, and direct contact between prospective employers and employees.

Most employment agencies maintain a database of prospective employees that allows them to match individual skills with a desired set of skills. Some employment agencies also record an interview with an employment seeker, which the agency then makes available for viewing by prospective employers.

However, logistics dictate that these recordings can only be viewed at a convenient time and location, which in most in stances means during business hours at the employment agency's offices.

Advertisements in newspapers and trade journals do not offer a practical solution to employment seekers because the advertisements are relatively expensive with a limited scope since few prospective employers would probably search through the “Work Wanted” columns of newspapers or trade journals. Word of mouth advertisements are even more limiting and have a very limited field of application.

In this specification the term “interview” means a video, movie or similar type of visual and audio recording of an interview with, and relating to the employability, of an employment seeker.

### SUMMARY OF CERTAIN INVENTIVE ASPECTS OF THE INVENTION

One aspect of the invention provides an employment system and method that alleviate at least some of the above-mentioned problems.

Another aspect of the invention provides an employment facilitating system comprising a database of information relating to employee characteristics including an interview, and at least one communication port allowing access to the database; the system being operable through the communication port to select information from the database for display on display means.

In one embodiment, the information includes employment seeker resume information and the resume information is displayable as text on the display means.

In one embodiment, the system is operable to receive information to be stored in the database for the system to be operable to classify the received information, and the information in the database is searchable according to a classification system.

In one embodiment, the communication port is connectable to a network and access to the database is controlled by means of a password. In one embodiment, the network includes a local area network, a wide area network and the Internet. In one embodiment, the system is operable by a service provider.

Another aspect of the invention provides a method of operating an employment facilitating system, comprising compiling a database of information relating to employee characteristics including at least one interview; and allowing access to the database through a communication port for the selection of information from the database to be displayed on display means.

In one embodiment, the method includes receiving information for storage in the database. In one embodiment, the method includes classifying received information, searching the information in the database according to a classification system and accessing the database by means of a password. In one embodiment, the method includes operating the system by means of a service provider.

### BRIEF DESCRIPTION OF THE DRAWINGS

An embodiment of the invention will be described below by way of example only and with reference to the accompanying drawing in which:

FIG. 1 is a schematic representation of an employment system according to one embodiment of the invention.

### DETAILED DESCRIPTION OF CERTAIN EMBODIMENTS OF THE INVENTION

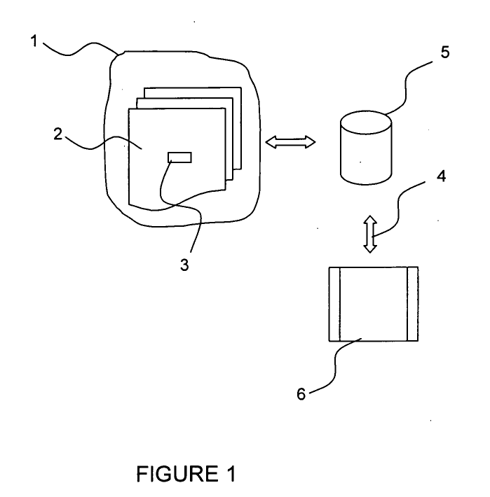

FIG. 1 shows a schematic representation of an employment system (1) according to one embodiment of the invention. The system (1) includes a database (2) in which data is stored, and a communications port (3) allowing access to the database (2). The data relates to the employability of employment seekers and, in particular, includes interviews with the employment seekers. Also included in the data are the associated resumes of the employment seekers.

The communications port (3) is accessible through a network (4), which in this instance is the Internet. A service provider (5) controls access to the database (2). A user (6) contacts the service provider (5) in the usual manner through the Internet (4) and once the correct user name and password has been provided to the service provider (5), access is provided to the contents of the database (2).

The data is classified and is searchable according to classification. The classification of the information is done, for example, according to the keywords associated with various employment fields, qualification, job title and so forth.

The user (6) is allowed to enter search criteria and thereby requests the service provider (5) to search the database (2). The service provider (5) searches the database (2) according to the search criteria of the user (6) and returns a summary of the search results to the user (6), including interviews and resumes.

For example, the user (6) may have searched for employment seekers in a particular employment field that are resident in a specific geographical area. The service provider (5) will provide the user (6) with a list of names of matching employment seekers, as well as their associated interviews and resumes.

The user (6) therefore receives a set of files including video clips of interviews and associated text documents of resumes at his computer. From these the interviews are displayable as video clips on the user's (6) computer display screen. The resumes are displayable as text documents on the display screen, for example in Portable Document Format (PDF) or WORD format, and are also printable. This enables the user (6) to peruse the resumes and interviews of the selected employment seekers at his own convenience, and to transmit the information to interested parities such as colleagues.

If the user (6) wishes to meet with a particular employment seeker he contacts the service provider (5), again via the Internet (4), to request contact details of the employment seeker. This is provided to the user (6) and personal contact can then be established between the user (6) and the employment seeker.

It is possible to use the system on a pay-per-view basis, where the user (6) pays a fixed amount per record viewed for searching through the database. It is also possible for a user (6) to pay an annual fee, which allows him unlimited access to the database (2). It is further possible to require a listing fee and a placement fee. This means that an employment seeker pays a periodical listing fee to have his information listed in the system (1) and an employer pays a placement fee if it employs a person that was listed in the system (1) and whom was introduced to the employer via the system (1).

The system (1) also allows employment seekers to submit their interviews, in for example MPEG format, and resumes to the system (1) via the Internet (4). This gives the opportunity to employees from anywhere in the world to submit their details to the system (1) for increased exposure.

The system (1) allows continuous, i.e. 24 hour per day, access to the information in the database (2). This is much more convenient, cost effective and productive than for example the prior art videotape banks which were located at employment agencies and which could only be viewed at agency offices.

It will be understood that this is only one embodiment of the invention, it is possible to alter some aspects of the embodiment without departing from the scope of the invention. It is for instance possible to use a network other than the Internet, for example a private local area network (LAN) or a wide area network (WAN).

While the above description has pointed out novel features of the invention as applied to various embodiments, the skilled person will understand that various omissions, substitutions, and changes in the form and details of the device of the device or process illustrated may be made without departing from the scope of the invention. Therefore, the scope of the invention is defined by the appended claims rather than by the foregoing description. All variations coming within the meaning and rage of equivalency of the claims are embraced within their scope.

1. A method of shared file and database access, comprising:
receiving a multimedia interview file and a resume file related to a job applicant via a network from a first remote location;
storing the received multimedia interview file and the resume file on a service provider's database at a centered location;
downloading the stored multimedia interview file and the resume file from the service provider's database to an employer's computing environment at a second remote location via a network;
retrieving, at the employer's computing environment, files associated with selected employee characteristics;
contacting an employee associated with the retrieved files; and
collecting and storing further information about the contacted employee on the employer's computing environment.

2. The method of claim 1, wherein the network includes one of the following: a local area network (LAN), a wide area network (WAN) and the Internet.

3. A shared file and database access system, comprising:
a service provider's database;
wherein the system is configured to allow a job applicant at a first remote location to upload a multimedia interview file and a resume file to the service provider's database via a network, and
wherein the system is further configured to allow an employer at a second remote location to download the multimedia interview file and the resume file from the service provider's database via a network.

4. The system of claim 3, further comprising:
a job applicant's computing device being in data communication with the database via a network; and
an employer's computing device being in data communication with the database via a network,
wherein the uploading is performed via the job applicant's computing device and the downloading is performed via the employer's computing device.

5. The system of claim 3, wherein the multimedia interview file includes a video, a movie or a similar type of visual and audio recording of an interview with, and relating to the employability, of the job applicant.

6. The system of claim 3, wherein the network includes one of the following: a local area network (LAN), a wide area network (WAN) and the Internet.

7. A shared file and database access system, comprising:
a database of information relating to employee characteristics including an interview; and
at least one communication port allowing access to the database;
wherein the system is operable through the communication port to select information from the database so as to display the selected information on a display device.

8. The system of claim 7, wherein the information includes employment seeker resume information and the resume information is displayable as text on the display device.

9. The system of claim 8, wherein the system is operable to receive information to be stored in the database.

10. The system of claim 9, wherein the system is operable to classify received information, and the information in the database is searchable according to a classification system.

11. The system of claim 10, wherein the communication port is connectable to a network.

12. The system of claim 11, wherein access to the database is controlled by means of a password.

13. The system of claim 12, the network includes one of the following: a local area network (LAN), a wide area network (WAN) and the Internet.

14. The system of claim 13, wherein the system is operable by a service provider.

15. A method of shared file and database access, the method comprising:
compiling a database of information relating to employee characteristics including at least one interview; and
allowing access to the database through a communication port for the selection of information from the database to be displayed on a display device.

16. The method of claim 15, further comprising receiving information so as to store the received information in the database.

17. The method of claim 16, further comprising classifying received information and searching the information in the database according to a classification system.

18. The method of claim 17, further comprising accessing the database by a password.

19. The method of claim 18, further comprising operating the system by a service provider.
